(19) United States
(12) Patent Application Publication
(10) Pub. No.: US 2025/0156738 A1
(43) Pub. Date: May 15, 2025

(54) GENERATIVE ARTIFICIAL INTELLIGENCE INCLUDING MAPPING QUESTIONS AND ANSWERS

(71) Applicant: Teachers Insurance and Annuity Association of America, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Sonam Jha, Short Hills, NJ (US)

(21) Appl. No.: 18/509,923

(22) Filed: Nov. 15, 2023

(51) Int. Cl. G06N 5/04; G06N 3/0475

(52) U.S. Cl. CPC G06N 5/04; G06N 3/0475

(57) ABSTRACT

The following relates generally to (i) building a data repository of question-answer pairs, and (ii) using the data repository to answer customer questions. In some embodiments, one or more processors: receive a first input statement; determine at least one domain corresponding to the first input statement; determine a first question based on the first input statement and the determined at least one domain; select based at least in part on the determined at least one domain, a generative AI model to apply to the first question; use the determined generative AI model to compose an answer to the first question; present the answer to a subject matter expert; receive, from the subject matter expert, approval of the answer; and in response to receiving approval, add the answer to a data repository.

### FIELD

The present disclosure generally relates to generative artificial intelligence (AI), and more particularly relates to: (i) building a data repository of question-answer pairs, and (ii) using the data repository to answer customer questions.

### BACKGROUND

Customers often seek advice from companies on a wide variety of topics. However, one challenge faced by many companies is that many jurisdictions prohibit giving financial advice and/or place other restrictions on advice that a company may wish to give. Thus, companies may wish to control how they respond to questions.

The systems and methods disclosed herein provide solutions to this challenge and may provide solutions to the ineffectiveness, insecurities, difficulties, inefficiencies, encumbrances, and/or other drawbacks of conventional techniques.

### SUMMARY

In one aspect, a computer-implemented method for generative artificial intelligence (AI) may be provided. In one example, the method may include: (1) receiving, via one or more processors, a first input statement; (2) determining, via the one or more processors, at least one domain corresponding to the first input statement; (3) determining, via the one or more processors, a first question based on the first input statement and the determined at least one domain; (4) selecting, via the one or more processors, based at least in part on the determined at least one domain, a generative AI model to apply to the first question; (5) using the determined generative AI model, composing, via the one or more processors, an answer to the first question; (6) presenting, via the one or more processors, the answer to a subject matter expert; (7) receiving, via the one or more processors, from the subject matter expert, approval of the answer; and (8) in response to receiving approval, adding, via the one or more processors, the answer to a data repository. The method may include additional, fewer, or alternate actions, including those discussed elsewhere herein.

In another aspect, a computer system for generative artificial intelligence (AI) may be provided. In one example, the computer system may include one or more processors configured to: (1) receive a first input statement; (2) determine at least one domain corresponding to the first input statement; (3) determine a first question based on the first input statement and the determined at least one domain; (4) select based at least in part on the determined at least one domain, a generative AI model to apply to the first question; (5) use the determined generative AI model to compose an answer to the first question; (6) present the answer to a subject matter expert; (7) receive, from the subject matter expert, approval of the answer; and (8) in response to receiving approval, add the answer to a data repository. The computer system may include additional, less, or alternate functionality, including that discussed elsewhere herein.

In yet another aspect, a computer device for generative artificial intelligence (AI) may be provided. In one example, the computer device may include: one or more processors; and/or one or more non-transitory memories coupled to the one or more processors. The one or more memories including computer executable instructions stored therein that, when executed by the one or more processors, may cause the one or more processors to: (1) receive a first input statement; (2) determine at least one domain corresponding to the first input statement; (3) determine a first question based on the first input statement and the determined at least one domain; (4) select based at least in part on the determined at least one domain, a generative AI model to apply to the first question; (5) use the determined generative AI model to compose an answer to the first question; (6) present the answer to a subject matter expert; (7) receive, from the subject matter expert, approval of the answer; and (8) in response to receiving approval, add the answer to a data repository. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computer system for (i) building a data repository of question-answer pairs, and/or (ii) using the data repository to answer customer questions in which the exemplary computer-implemented methods described herein may be implemented.

FIG. 2 illustrates an overview of an example diagram for (i) building a data repository of question-answer pairs, and/or (ii) using the data repository to answer customer questions.

FIG. 3 illustrates an example input system.

FIG. 4 illustrates an example domain prompts system.

FIG. 5 illustrates an example generative AI system.

FIG. 6 illustrates an example generative AI models repository.

FIG. 7 illustrates an example domain documents system.

FIG. 8 illustrates an example human review system.

FIG. 9 depicts an example data repository.

FIG. 10 shows an exemplary computer-implemented method or implementation for (i) building a data repository of question-answer pairs, and/or (ii) using the data repository to answer customer questions.

FIG. 11 depicts an example method or implementation of determining if a question is a new question.

FIG. 12 depicts an example screen of a customer computing device.

FIG. 13 depicts an example screen of a subject matter expert computing device.

### DETAILED DESCRIPTION

Customers often seek advice from companies on a wide variety of topics. However, one challenge faced by many companies is that many jurisdictions prohibit giving financial advice and/or place other restrictions on advice that a company may wish to give. Thus, companies may wish to control how they respond to questions.

The systems and methods described herein may provide solutions to this challenge and others. For example, according to embodiments described herein, each answer presented to a customer may be approved by a subject matter expert (e.g., a human). In this way, the subject matter expert is able to determine that the answer does not provide financial advice and/or complies with other applicable laws.

Broadly speaking, the systems and methods described herein may build a data repository of question-answer pairs. Sometimes, as described herein, this may be referred to as a “trusted” data repository. In some embodiments, the question-answer pairs have been approved by the subject matter expert, thereby ensuring that the answers do not provide financial advice and/or comply with other applicable laws.

### Example System

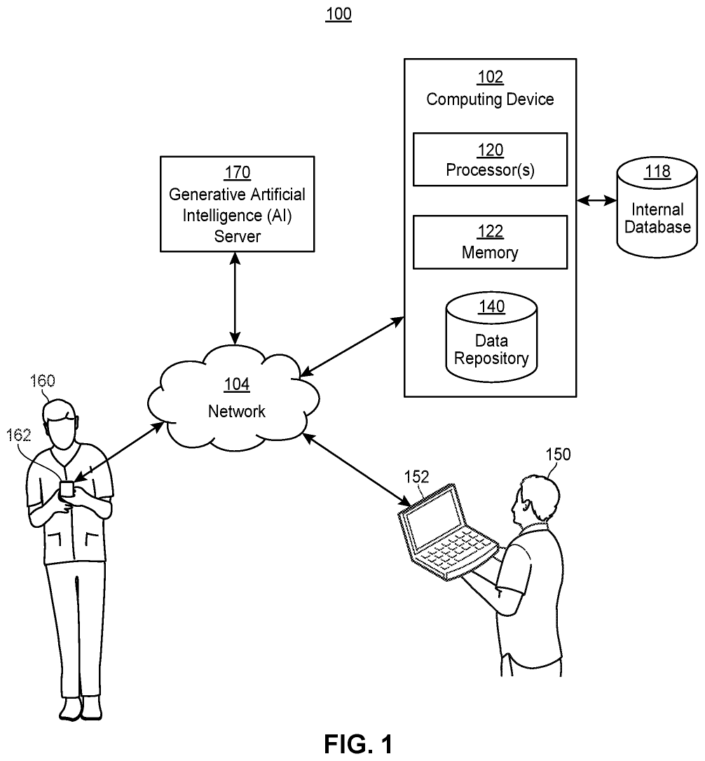

To this end, FIG. 1 illustrates an exemplary computer system 100 for (i) building a data repository of question-answer pairs, and/or (ii) using the data repository to answer customer questions in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the insurance server 102 to provide access to the computer-readable instructions stored thereon. In particular, the computer-readable instructions stored on the memory 122 may include instructions for executing various applications.

In operation, the computing device 102 may build the data repository 140. The data repository 140 may, among other things, store question-answer pairs. Advantageously, storing the question-answer pairs in the data repository 140 allows only answers that have already been approved (e.g., answers that have been determined not to contain financial advice and/or been determined to be in compliance with all applicable laws) to be presented to customer 160.

In some examples, the computing device uses information from an internal database 118 as part of building the data repository 140. The internal database 118 may hold any suitable information, such as domain information (e.g., retirement information, cyber information, legal information, compliance information, human resources information, privacy information, and/or fairness information).

The subject matter expert 150 may be the entity that approves question-answer pairs, and/or approves answers. In the example of FIG. 1, the subject matter expert 150 is a human. However, it should be understood that, in some embodiments, the subject matter expert 150 may be a computing device and/or an algorithm (e.g., an AI algorithm, etc.) that approves the question-answer pairs and/or approves answers.

The subject matter expert 150 may use a subject matter expert computing device 152. The subject matter expert computing device 152 may be any suitable device, such as a computer, a mobile device, a smartphone, a laptop, a phablet, a chatbot or voice bot, etc. The subject matter expert computing device 152 may include one or more display devices, one or more processors, one or more memories, etc.

The customer 160 may be any customer seeking advice. Examples of the customer 160 include an employee of an institution (e.g., a person working for an institution seeking advice for the institution, etc.), consultants (e.g., an individual hired by an institution to provide advice, etc.), and an individual (e.g., an individual with a retirement account seeking advice related to the retirement account, etc.).

The customer 160 may use a customer computing device 162. The customer computing device 162 may be any suitable device, such as a computer, a mobile device, a smartphone, a laptop, a phablet, a chatbot or voice bot, etc. The customer computing device 162 may include one or more display devices, one or more processors, one or more memories, etc.

In some embodiments, the computing device 102 may select and/or use various generative AI programs. In some such examples, generative AI programs may be run on the generative AI server 170. It should be understood that the generative AI server 170 may include one or more processors, one or more memories, etc.

In addition, further regarding the example system 100, the illustrated exemplary components may be configured to communicate, e.g., via a network 104 (which may be a wired or wireless network, such as the internet), with any other component. Furthermore, although the example system 100 illustrates only one of each of the components, any number of the example components are contemplated (e.g., any number of computing devices, subject matter expert computing devices, customer computing devices, generative AI servers, etc.).

### Example Architecture

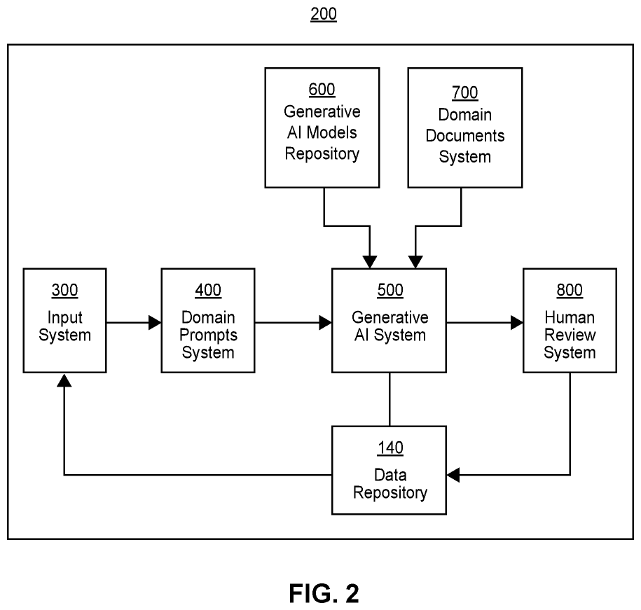

FIG. 2 illustrates an overview of an example diagram 200 for (i) building a data repository of question-answer pairs, and/or (ii) using the data repository to answer customer questions.

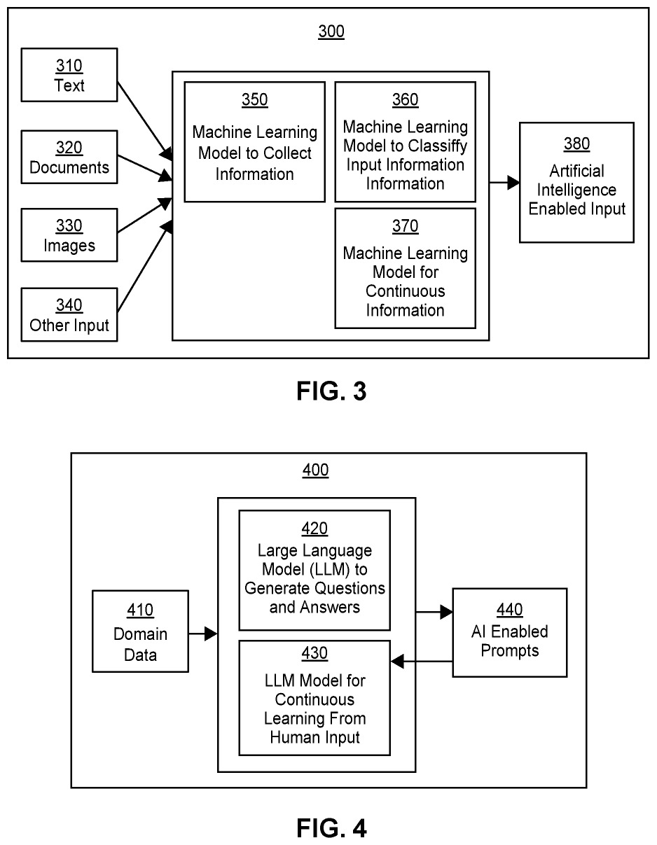

In some embodiments, the example diagram 200 may begin with input system 300. A more detailed view of an example input system 300 is illustrated by FIG. 3. With reference to FIG. 3, the example input system block 300 may include receiving an input statement, such as text 310, documents 320, images 330, or other input 340.

The input system 300 may further include ML model to collect information 350 (e.g., collect any of the input statements 310, 320, 330, 340). Once collected, the information may be sent to the ML model to classify input information 360, which may classify input statements into one or more domains.

Examples of domains include: retirement, cyber, legal, compliance, human resources, privacy, and/or fairness. For example, the input statement “what retirement programs does company XYZ offer” would be in the retirement domain.

The cyber domain may include technology related input statements. Likewise, the legal domain may include legal related input statements. The compliance domain may include compliance related input statements (e.g., compliance with regulations, etc.). The human resources domain may include human resource related input statements. The privacy domain may include privacy related input statements. In the fairness domain may include fairness related input statements.

The input system 300 may further include ML model for continuous information 370. This model may be used to continuously improve the domain classification. For example, a human (e.g., the subject matter expert 150) may correct a domain (or add an additional domain) that the ML model to classify input information 360 indicated for an input statement, and this feedback may be used to continuously improve the domain classification.

The input system 300 may further include AI enabled input 380. In some examples, the AI enabled input 380 comprises the input statement along with the domain classification(s).

Returning to FIG. 2, the input system 300 may feed data to the domain prompts system 400. A more detailed view of an example domain prompts system 400 is illustrated by the example of FIG. 4. The domain prompts system 400 may include domain data 410 (e.g., received from the input system 300). In some embodiments, the domain data 410 comprises the AI enabled input 380.

The domain prompts system 400 may further include LLM to generate questions and answers 420. For example, a question-answer pair may be determined from the input statement and its domain (e.g., the input statement and domain are comprised in the domain data 410).

The domain prompts system 400 may further include LLM model for continuous learning from human input 430, which may enable continuous improvement. For example, a human may rank or score questions, answers, and/or question-answer pairs (e.g., produced by the LLM to generate questions and answers 420); and this feedback may be used to continuously improve determination of the questions, answers, and/or question-answer pairs. The output of the LLM to generate questions and answers 420 may be the AI enabled prompts 440.

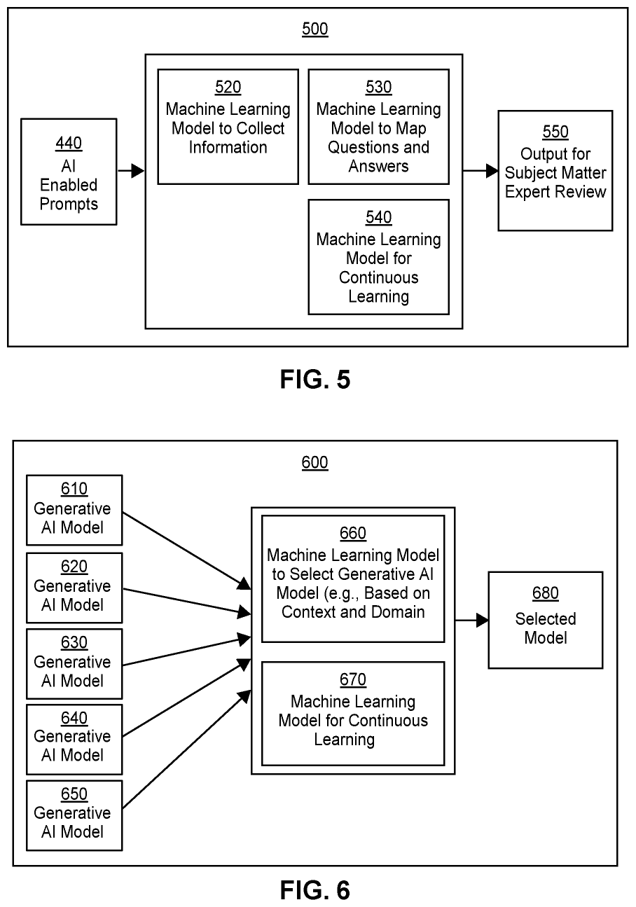

Returning to FIG. 2, the domain prompts system 400 may feed data to the generative AI system 500. A more detailed view of an example generative AI system 500 is illustrated by FIG. 5. With reference thereto, the example generative AI system 500 may receive the AI enabled prompts 440 from the domain prompts system 400. The generative AI system 500 may further include ML model to collect information 520.

The generative AI system 500 may further include ML model to map questions and answers 530. In some embodiments, the ML model to map questions and answers 530 may determine and/or use confidence score(s) and/or threshold(s) to map questions and answers, and/or determine if the question is a new question, as will be described further below.

The generative AI system 500 may further include ML model for continuous learning 540. The ML model for continuous learning 540 may continuously train the ML model to map questions and answers 530. For example, the machine learning model for continuous learning 540 may receive feedback from a human (e.g., the subject matter expert 150) including question-answer pairs, and use this feedback to further train the ML model to map questions and answers 530.

The generative AI system 500 may further include output for subject matter expert review 550, which may be sent to the human review system 800. The output for subject matter review 550 may include, for example, questions, answers, and/or question-answer pairs.

Returning again to FIG. 2, the generative AI system 500 may receive data from the generative AI models repository 600. A more detailed view of an example generative AI models repository 600 is illustrated by the example of FIG. 6. With reference thereto, the example generative AI models repository 600 may include generative AI models 610, 620, 630, 640, 650.

The generative AI models repository 600 may further include ML model to select generative AI model 660. In some embodiments, the ML model to select generative AI model 660 may select a generative AI model based on context and type of data.

The generative AI models repository 600 may further include ML model for continuous learning 670. In some embodiments, the ML model for continuous learning 670 may facilitate continuous learning by receiving question-answer pairs along with knowledge of if the question-answer pairs have been accepted or rejected by the subject matter expert 150. For instance, the ML model for continuous learning 670 may use this information to further train the ML model to select generative AI models 660, thereby advantageously improving performance of the system.

The generative AI models repository 600 may further include selected model 680. In some embodiments, the selected model 680 may be selected from one or more of the generative AI models 610, 620, 630, 640, 650.

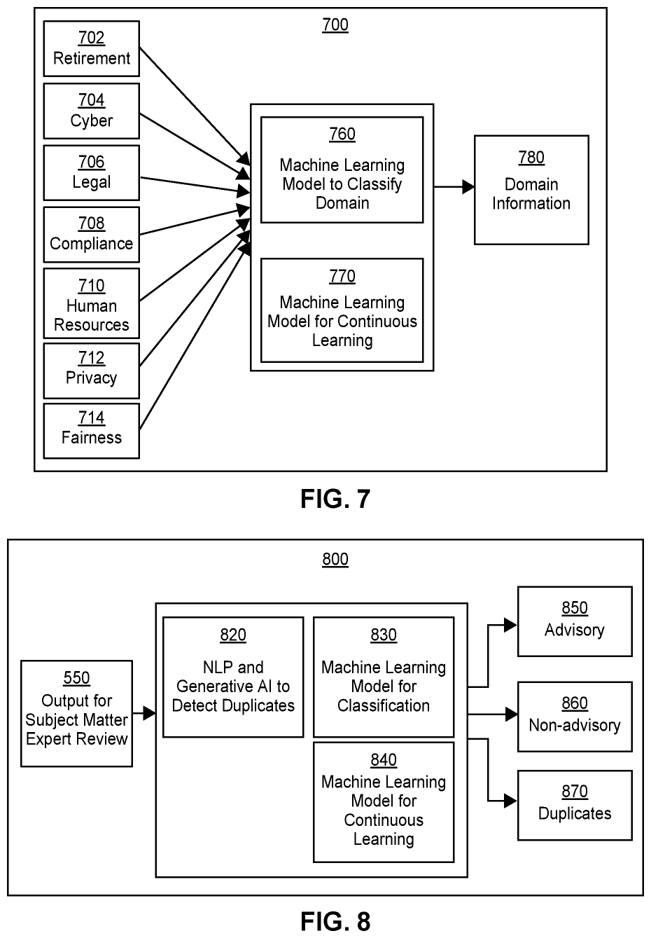

Returning again to FIG. 2, the generative AI system 500 may further receive data from domain documents system 700. A more detailed view of an example domain documents system 700 is illustrated by FIG. 7. With reference thereto, the domain documents system 700 may include or receive data or documents corresponding to different domains. In the illustrated example, this is depicted by retirement 702, cyber 704, legal 706, compliance 708, human resources 710, privacy 712, and fairness 714. The domain documents system 700 may further include ML model to classify domain 760, which may classify input statements and/or questions into any of the domains.

The domain documents system 700 may further include ML model for continuous learning 770, which may receive information to further train the ML model to classify domain 760. For example, the subject matter expert 150 may provide feedback on whether questions and/or input statements have been classified another correct domain, which the ML model for continuous learning 770 may use for the training.

The domain documents system 700 may further include domain information 780 (e.g., the output of the machine learning model to classify domain 760).

Returning again to FIG. 2, the output for subject matter expert review 550 may be sent to the human review system 800. A more detailed view of an example human review system 800 is illustrated by FIG. 8. With reference thereto, the output for subject matter expert review 550 may be sent to the NLP and generative AI to detect duplicates 820, machine learning model for classification 830, and/or machine learning model for continuous learning 840.

The NLP generative AI to detect duplicates 820 may detect duplicates 870. Advantageously, the detection of duplicates allows for duplicates not be presented to the subject matter expert 150, thus saving processing power and preserving battery life at the subject matter expert computing device 152.

Additionally or alternatively, advantageously, answers to the duplicates may be merged to facilitate subject matter expert review, thereby creating even better answers and/or saving processing power and preserving battery life at the subject matter expert computing device 152.

The machine learning model for classification 830 may classify the output for subject matter expert review 550 into advisory 850 and non-advisory 860 categories. In some embodiments, and advisory classification indicates that the output for subject matter review 550 includes financial advice; and a non-advisory classification indicates that the output for subject matter review 550 does not include financial advice.

The machine learning model for continuous learning 840 may receive information to help continuously train the machine learning model for classification 830. For example, the subject matter expert 150 may provide feedback on whether output for subject matter expert review 550 has been classified correctly into the advisory or non-advisory categories, which the ML model for continuous learning 840 may use for the training.

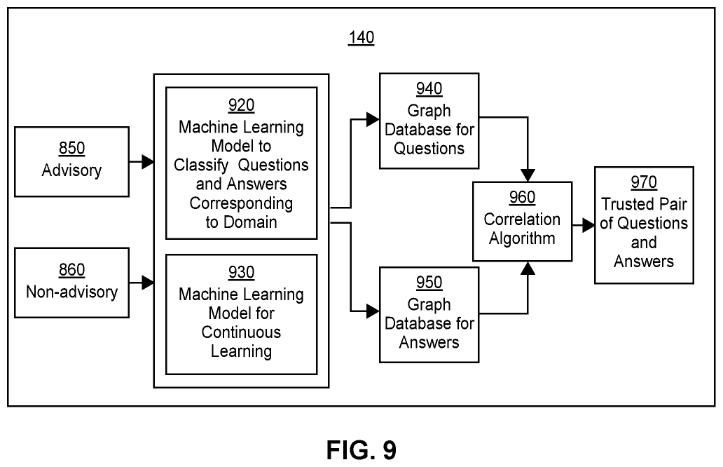

Returning again to FIG. 2, the human review system 800 may send the advisory 850 and the non-advisory 860 to the data repository 140. FIG. 9 depicts an example data repository 140. With reference thereto, the machine learning model to classify questions and answers corresponding to domain 920 may classify the advisory 850 and/or non-advisory 860 into domains.

The machine learning model for continuous learning 930 may receive information to help continuously train the ML model to classify questions and answers corresponding to domain 920. For example, the subject matter expert 150 may provide feedback on whether the output of the ML model to classify questions and answers corresponding to domain 920 has made the correct domain classification, which the ML model for continuous learning 930 may use for the training.

The output of the ML model to classify questions and answers corresponding to domain 920 may be stored in one or both of the graph database for questions 940 and/or the graph database for answers 950. One or both of the graph database for questions 940 and/or the graph database for answers 950 may be graph databases that store nodes and/or relationships instead of tables.

The correlation algorithm 960 may correlate questions (e.g., from the graph database for questions 940) with answers (e.g., from the graph database for answers 950) to create the trusted pair of questions and answers 970.

### Example Methods

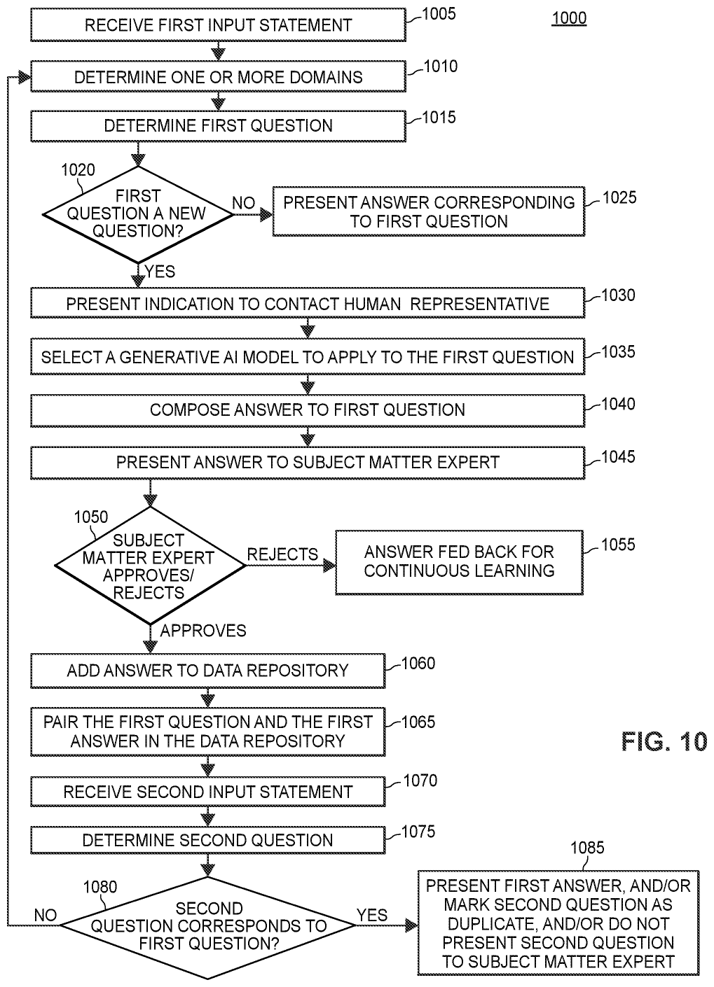

FIG. 10 shows an exemplary computer-implemented method or implementation 1000 for (i) building a data repository of question-answer pairs, and/or (ii) using the data repository to answer customer questions. Although the following discussion refers to the exemplary method or implementation 1000 as being performed by the one or more processors 120, it should be understood that any or all of the blocks may be alternatively or additionally performed by any other suitable component as well (e.g., one or more processors of the subject matter expert computing device 152, one or more processors of the customer computing device 162, one or more processors of the generative AI server 170, etc.).

The example method or implementation 1000 may begin at block 1005 when the one or more processors 120 receive a first input statement. Examples of the first input statement include text 310, documents 320, images 330, and/or other input 340. The first input statement may be received from any suitable component, such as the customer computing device 162, the subject matter expert computing device 152, the generative AI server 170, etc.

At block 1010, the one or more processors 120 may determine one or more domains corresponding to the first input statement. Examples of domains include: retirement, cyber, legal, compliance, human resources, privacy, and/or fairness.

The one or more domains may be determined by any suitable technique. In some examples, the one or more domains are determined by the machine learning model to classify input information 360. In some examples, the domains are determined (e.g., by the machine learning model to classify input information 360) based on keywords or phrases found in the input statement.

Additionally or alternatively, a human may manually enter the domain. For instance, the subject matter expert 150 may read the input statement and use the subject matter expert computing device 152 to label the input statement with a domain. In this way, the machine learning model for continuous information 370 may receive input from humans to continuously improve performance of the domain categorization.

At block 1015, the one or more processors 120 may determine a first question (e.g., a first question corresponding to the first input statement). The first question may be determined by any suitable technique. For example, the first question may be determined based on the first input statement and/or the determined one or more domains. In some examples, the first question may be determined by the LLM to generate questions and answers 420.

At decision block 1020, the one or more processors 120 determine if the first question is a new question. The determination of if the question is a new question may be made by any suitable technique. For example, the one or more processors 120 may determine if the first question corresponds to a question (e.g., an existing question) stored in the data repository 140 or other suitable component (if so, the first question is not a new question).

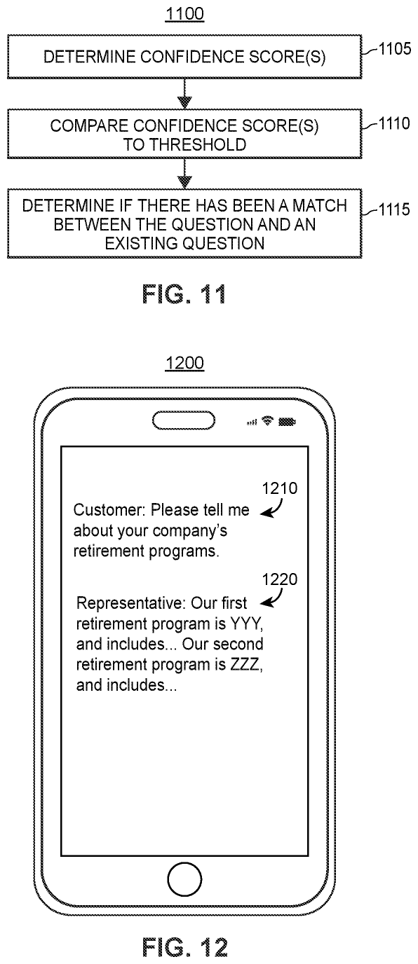

FIG. 11 depicts an example method or implementation 1100 of determining if a question is a new question (e.g., an example method or implementation of performing block 1020). At block 1105, the one or more processors 120 may determine one or more confidence scores. In some embodiments, the confidence scores may indicate a confidence that the question corresponds to a particular existing question. Thus, in some embodiments, there is a confidence score between the question and each existing question.

For example, the confidence scores may be determined by comparing features of the question with features of an existing question or questions (e.g., via the machine learning model to map questions and answers 530, etc.). In some examples, the comparisons of features of the question to features of existing questions are made only between existing questions of the same domain(s) as the question. Advantageously, this improves technical functioning by saving computing resources and processing power (e.g., because the number of comparisons that must be made is greatly reduced).

At block 1110, the confidence scores may be compared to a threshold (e.g., via the machine learning model to map questions and answers 530, etc.). Based on the comparison(s), the one or more processors 120 may determine if the question is a match with an existing question. For example, whether a confidence score is above or below the threshold may determine if the question is a match, depending on the embodiment.

In some such examples, the threshold is a dynamic threshold. That is, the threshold may change with certain factors. For instance, the threshold may be based on (i) a content of the question, and/or (ii) a risk rating of the question.

In some examples, if the content of the question corresponds to content for which a high amount of information is available, the dynamic threshold is set higher (e.g., higher than for content for which a lower amount of information is available, such as in the data repository 140, the memory 122, the internal database 118, etc.). Advantageously, this creates more specific answers to questions for which a high amount of information is available.

In some examples, if the content of the question has a higher risk, the dynamic threshold is set higher (e.g., higher than for a question with a low risk). Advantageously, this safeguards against sending a wrong answer to a question. In some examples, a general question has a lower risk, whereas a specific question has a higher risk. For example, a general question might ask, “what retirement programs does your company offer?” In contrast, a more specific question would ask, “My name is John Doe. I am 55 years old, and am employed as an accountant with $AAA in annual income, and $BBB saved for retirement. My goal is to retire with $CCC in monthly income. What age can I retire at?” As can be seen from these examples, the risk of presenting an inaccurate answer is greater for more specific questions.

If the first question is not a new question, in some embodiments, at block 1025, the one or more processors 120 may present an answer corresponding to the first question. The answer corresponding to the question may be determined by any suitable technique. For example, the confidence scores discussed above may be used to determine the corresponding answer. For instance, if confidence scores are calculated between the question and some or all of the answers, the corresponding answer may be determined to be the answer with the highest confidence score.

At block 1115, the one or more processors 120 may determine if there has been a match between the question and existing question (e.g., based on the comparisons done at block 1110). If so, the question may be determined to be not a new question. If not, the question may be determined to be a new question. In some embodiments, if the question is determined to be a new question, one or more of the answers that the question was compared to may be placed on a list for the subject matter expert 150 to determine why the one or more of the answers were not a match to the question. Subsequently, the one or more answers may be presented to the subject matter expert 150 (e.g., via the subject matter expert computing device 152).

Returning now to FIG. 10, if the answer at decision block 1020 is no, the answer corresponding to the first question may be presented (e.g., to the customer 160 via the customer computing device 162). For example, for the question found to be a match for the first question based on the confidence score, the answer corresponding to the question may be retrieved from the data repository 140.

The presentation may be made via any suitable technique. For example, the presentation may include displaying the answer on any display (e.g., a display of the customer computing device 162, a display of the subject matter expert computing device 152, etc.). Additionally or alternatively, the answer may be delivered in auditory form (e.g., via the customer computing device 162, or the subject matter expert computing device 152, etc.).

If the answer at decision block 1020 is yes, the one or more processors 120 may present an indication to contact a human representative (block 1030). The presentation may be made via any suitable technique. For example, the presentation may include displaying the indication on any display (e.g., a display of the customer computing device 162, a display of the subject matter expert computing device 152, etc.). Additionally or alternatively, the indication may be delivered in auditory form (e.g., via the customer computing device 162, or the subject matter expert computing device 152, etc.).

At block 1035, the one or more processors 120 (e.g., via the ML model to select generative AI model 660) may select a generative AI model to apply to the first question. The generative AI model may be selected based on any criteria. Examples of the criteria that may be used to select the generative AI model include context of the input statement and domain. In some embodiments, the generative AI model includes a large language model (LLM).

Advantageously, selection of a generative AI model allows the system to more specifically present appropriate answers to users. For example, if the context of an input statement indicates that a more humanlike response is appropriate, a generative AI model that gives more humanlike answers may be selected. Alternatively, if the context of the input statement indicates that a more exact and/or factual answer is appropriate, a generative AI model that gives more exact and/or factual answers may be selected. In another example, if the domain of the input statement and/or first question is determined to be cyber, a generative AI model that is known to give particularly good answers to cyber questions may be selected.

At block 1040, the one or more processors 120 may compose an answer to the first question. For example, the generative AI model selected at block 1035 (e.g., selected model 680) may be used to compose the answer to the first question.

It should be understood that any or all of blocks 1030, 1035, and/or 1040 may occur in response to the determination that the first question is a new question (e.g., at block 1020).

At block 1045, the answer determined at block 1040 may be presented (e.g., to the subject matter expert 150 via the subject matter expert computing device 152, etc.). The presentation may be made via any suitable technique. For example, the presentation may include displaying the indication on any display (e.g., a display of the subject matter expert computing device 152, a display of the customer computing device 162, etc.). Additionally or alternatively, the indication may be delivered in auditory form (e.g., via the subject matter expert computing device 152, the customer computing device 162, etc.).

In some embodiments, the answer alone is presented to the subject matter expert 150. In other embodiments, the presenting the answer to a subject matter expert comprises presenting the answer along with the first question as a question-answer pair to the subject matter expert 150.

At block 1050, the subject matter expert 150 approves or rejects the answer. For example, the subject matter expert 150 may approve the answer if she believes that it does not contain financial advice and/or complies with all applicable laws. Advantageously, this ensures that each answer that will be presented to the customer 160 does not contain financial advice and/or complies with all applicable laws.

The subject matter expert 150 may approve or reject the answer via any suitable technique. For example, the subject matter expert 150 may approve or reject the answer via the subject matter expert computing device 152.

If the subject matter expert 150 rejects the answer (or the question-answer pair), the answer is fed back to the system (e.g., to the machine learning model for continuous learning 540, the machine model for continuous learning 670, the machine learning model for continuous learning 840, or any other suitable component) for continuous learning (block 1055). For example, the models may “learn” from the rejected answer. For instance, the machine learning model to select generative AI model 660 may learn to select a different generative AI model for a similar question based on the knowledge that the answer was rejected.

If the answer (or the question-answer pair) is approved, at block 1060, the answer may be added to the data repository 140. The answer may be added singularly, or added along with its corresponding question as a question-answer pair, or any other suitable form.

At block 1065, the one or more processors 120 may pair the first question and the first answer in the data repository 140 (e.g., if the question and answer are received separately). In some embodiments, the question is stored in the graph database for questions 940, and/or the answer is stored in the graph database for answers 950.

At block 1070, the one or more processors 120 receive a second input statement. As should be appreciated, examples of the second input statement may be the same as other input statements described elsewhere herein, such as text 310, documents 320, images 330, and/or other or other input 340.

At block 1075, the one or more processors 120 may determine a second question. The second question may be determined similarly to the first question (e.g., at block 1015).

At block 1080, the one or more processors 120 may determine if the second question corresponds to the first question. If not, the exemplary method or implementation 1000 may return to block 1010 and the one or more processors 120 may determine one or more domains of the second question. It should be appreciated that from here the method may continue to reiterate except with the second question instead of the first question.

If, at block 1080, the second question is determined to correspond to the first question, the first answer is presented (e.g., at block 1085) to the customer 160 (e.g., via the customer computing device 162, etc.). The presentation may be made as discussed elsewhere herein (e.g., displayed on a display of the customer computing device 162, presented in auditory form via the customer computing device 162, etc.).

Further at block 1085, the second question may be marked as a duplicate (e.g., by the NLP and generative AI to detect duplicates 820, etc.). The second question may further be stored as a duplicate 870. Advantageously, the second question, in some embodiments, may not be presented to the subject matter expert 150, thus saving processing power and preserving battery life at the subject matter expert computing device 152.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal and/or flowcharts may include additional, less, or alternate functionality, including that discussed elsewhere herein.

### Example Displays

FIG. 12 depicts an example screen 1200 of the customer computing device 162. With reference thereto, the customer 160 has entered input statement 1210, “Please tell me about your company's retirement programs.” In the illustrated example, the customer 160 is presented with the answer 1220, “Our first retirement program is YYY, and includes. . . . Our second retirement program is ZZZ, and includes . . . ”

One example implementation of how the system may present the answer 1220 may be understood via the examples of FIGS. 10 and 11. For instance, the one or more processors 120 may determine the domain of the input statement 1210 to be retirement. Next, the one or more processors 120 may determine a question from the input statement 1210 to be “what is companies XYZ's retirement programs?” (e.g., block 1015). In some example implementations, the question may be determined not to be a new question (e.g., block 1020); and thus the corresponding answer 1220 is found in the data repository 140, and then presented to the customer 160 (e.g., block 1025).

In other example implementations, the question may be determined to be a new question (e.g., block 1020), and an indication to contact a human representative may be presented to customer 160 (e.g., block 1030). Further, a generative AI model may be selected to apply to the question (e.g., block 1035), and the selected generative AI model may compose an answer (e.g., block 1040).

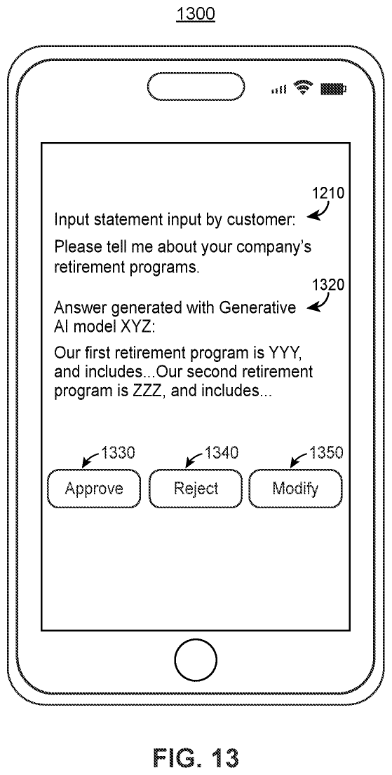

The answer may then be presented to the subject matter expert 150 (e.g., block 1045). FIG. 13 shows one example screen 1300 (e.g., of the subject matter expert computing device 152) of the presentation to the subject matter expert 150. The example screen 1300 may include the answer 1320 along with an indication of which generative AI model compose the answer. Options for the subject matter expert 150 to approve 1330, reject 1340, or modify 1350 may also be presented.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing.” “calculating.” “determining.” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising.” “includes,” “including.” “has.” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generative artificial intelligence (AI), the method comprising:
receiving, via one or more processors, a first input statement;
determining, via the one or more processors, at least one domain corresponding to the first input statement;
determining, via the one or more processors, a first question based on the first input statement and the determined at least one domain;
selecting, via the one or more processors, based at least in part on the determined at least one domain, a generative AI model to apply to the first question;
using the determined generative AI model, composing, via the one or more processors, an answer to the first question;
presenting, via the one or more processors, the answer to a subject matter expert;
receiving, via the one or more processors, from the subject matter expert, approval of the answer; and
in response to receiving approval, adding, via the one or more processors, the answer to a data repository.

2. The computer-implemented method of claim 1, further comprising, subsequent to adding the answer to the data repository:
pairing, via the one or more processors, the first question and the answer in the data repository;
receiving, via the one or more processors, a second input statement;
determining, via the one or more processors, that the second input statement corresponds to the first question; and
in response to the determining that the second input statement corresponds to the first question, presenting, via the one or more processors, the answer on a display.

3. The computer-implemented method of claim 1, further comprising determining, via the one or more processors, that the first question is a new question by: (i) determining confidence scores indicating similarity between the first question and respective existing questions, and (ii) comparing the confidence scores to a threshold; and
wherein the composing the answer to the first question occurs in response to the determining that the first question is a new question.

4. The computer-implemented method of claim 3, wherein the threshold is a dynamic threshold, and is based on (i) a content of the first question, and (ii) a risk rating of the first question.

5. The computer-implemented method of claim 3, further comprising:
further in response to the determining that the first question is a new question, displaying, via the one or more processors, to a customer, an indication to contact a human representative.

6. The computer-implemented method of claim 1, wherein the at least one domain includes at least one of:
retirement;
cyber;
legal;
compliance;
human resources;
privacy; or
fairness.

7. The computer-implemented method of claim 1, wherein:
the presenting the answer to the subject matter expert comprises presenting the answer along with the first question as a question-answer pair to the subject matter expert; and
the receiving the approval comprises receiving approval of the question-answer pair.

8. The computer-implemented method of claim 1, further comprising:
receiving, via the one or more processors, a second input statement;
determining, via the one or more processors, a second question from the second input statement;
determining, via the one or more processors, that the second question is a duplicate of the first question; and
in response to the determining that the second question is a duplicate of the first question, not presenting, via the one or more processors, the second question to the subject matter expert.

9. A system for generative artificial intelligence (AI), comprising one or more processors configured to:
receive a first input statement;
determine at least one domain corresponding to the first input statement;
determine a first question based on the first input statement and the determined at least one domain;
select based at least in part on the determined at least one domain, a generative AI model to apply to the first question;
use the determined generative AI model to compose an answer to the first question;
present the answer to a subject matter expert;
receive, from the subject matter expert, approval of the answer; and
in response to receiving approval, add the answer to a data repository.

10. The system of claim 9, wherein the one or more processors are further configured to, subsequent to adding the answer to the data repository:
pair the first question and the answer in the data repository;
receive a second input statement;
determine that the second input statement corresponds to the first question; and
in response to the determining that the second input statement corresponds to the first question, present the answer on a display.

11. The system of claim 9, wherein the one or more processors are further configured to:
determine that the first question is a new question by: (i) determining confidence scores indicating similarity between the first question and respective existing questions, and (ii) comparing the confidence scores to a threshold; and
compose the answer to the first question in response to the determination that the first question is a new question.

12. The system of claim 11, wherein the threshold is a dynamic threshold, and is based on (i) a content of the first question, and (ii) a risk rating of the first question.

13. The system of claim 11, wherein the one or more processors are further configured to:
further in response to the determining that the first question is a new question, display, to a customer, an indication to contact a human representative.

14. The system of claim 9, wherein the at least one domain includes at least one of:
retirement;
cyber;
legal;
compliance;
human resources;
privacy; or
fairness.

15. The system of claim 9, wherein:
the present the answer to the subject matter expert comprises presenting the answer along with the first question as a question-answer pair to the subject matter expert; and
the receive of the approval comprises receiving approval of the question-answer pair.

16. The system of claim 9, wherein the one or more processors are further configured to:
receive a second input statement;
determine a second question from the second input statement;
determine that the second question is a duplicate of the first question; and
in response to the determining that the second question is a duplicate of the first question, not present the second question to the subject matter expert.

17. A computer device for generative artificial intelligence (AI), the computer device comprising:
one or more processors; and
one or more non-transitory memories, the one or more non-transitory memories having stored thereon computer-executable instructions that, when executed by the one or more processors, cause the one or more processors to:
receive a first input statement;
determine at least one domain corresponding to the first input statement;
determine a first question based on the first input statement and the determined at least one domain;
select based at least in part on the determined at least one domain, a generative AI model to apply to the first question;
use the determined generative AI model to compose an answer to the first question;
present the answer to a subject matter expert;
receive, from the subject matter expert, approval of the answer; and
in response to receiving approval, add the answer to a data repository.

18. The computer device of claim 17, the one or more non-transitory memories having stored thereon computer executable instructions that, when executed by the one or more processors, cause the one or more processors to, subsequent to adding the answer to the data repository:
pair the first question and the answer in the data repository;
receive a second input statement;
determine that the second input statement corresponds to the first question; and
in response to the determining that the second input statement corresponds to the first question, present the answer on a display.

19. The computer device of claim 17, the one or more non-transitory memories having stored thereon computer executable instructions that, when executed by the one or more processors, cause the one or more processors to:
determine that the first question is a new question by: (i) determining confidence scores indicating similarity between the first question and respective existing questions, and (ii) comparing the confidence scores to a threshold; and
compose the answer to the first question in response to the determination that the first question is a new question.

20. The computer device of claim 19, wherein the threshold is a dynamic threshold, and is based on (i) a content of the first question, and (ii) a risk rating of the first question.
